(19) United States
(12) Patent Application Publication
(10) Pub. No.: US 2009/0003846 A1
(43) Pub. Date: Jan. 1, 2009

(54) HOST APPARATUS CONNECTED TO IMAGE FORMING APPARATUS AND IMAGE FORMING METHOD THEREOF

(75) Inventor: Hyung-jae YOO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co.,Ltd, Suwon-si (KR)

(21) Appl. No.: 12/144,875

(22) Filed: Jun. 24, 2008

(30) Foreign Application Priority Data
Jun. 27, 2007 (KR) 2007-63965

(51) Int. Cl. G03G 15/00

(52) U.S. Cl. 399/8

(57) ABSTRACT

A host apparatus which is connected to an image forming apparatus, the host apparatus includes an image processor to process an image with respect to a printing data, and a controller to check a preset common printing property for two or more printing data, to set a common printing property to be applied for the two or more selected printing data and to control the image processor to process the image with respect to the selected printing data and to transmit the set common printing property with the selected printing data to the image forming apparatus.

### CROSS-REFERENCE TO RELATED APPLICATIONS

This application claims priority under 35 U.S.C. §119(a) from Korean Patent Application No. 10-2007-0063965, filed on Jun. 27, 2007 in the Korean Intellectual Property Office, the disclosure of which is incorporated herein in its entirety by reference.

### BACKGROUND OF THE INVENTION

1. Field of the Invention

The present general inventive concept relates to a host apparatus connected to an image forming apparatus and an image forming method thereof, and more particularly, to a host apparatus which is connected to an image forming apparatus and sets a printing property of a plurality of printing jobs, and an image forming method thereof.

2. Description of the Related Art

An image forming apparatus forms an image based on printing data. The image forming apparatus forms an image having various properties according to a user's command. An image forming system includes the image forming apparatus and a host apparatus. The image forming apparatus receives a command generated by the host apparatus and is assigned with a property set by the command. Printer job language (PJL) may be used for the command to assign the properties.

PJL command uses a command SET to set a property of a single job, and a command DEFAULT to set a common property of overall printing jobs for a plurality of printing data. A command Nested Jobs is used to assign a common property to a plurality of the particular printing data.

FIG. 1 illustrates a command which is generated to assign a property to a plurality of printing jobs in a conventional host apparatus connected to an image forming apparatus. As illustrated therein, the conventional host apparatus generates and adds a command “Nested Jobs” to line 1 and line 11 to print four copies with printing job 1 and printing job 2.

However, the image forming apparatus which is connected to the conventional host apparatus requires logic to parse the command “Nested Jobs”, and thus has a difficulty in setting a same property for two or more printing jobs. Also, the image forming apparatus may not process the printing job quickly due to a need to process additional commands.

### SUMMARY OF THE INVENTION

The present general inventive concept provides a host apparatus which is connected to an image forming apparatus and sets a printing property of two or more printing jobs with commands from a conventional printer job language (PJL) without difficulty, and an image forming method thereof.

The present general inventive concept also provides a host apparatus which is connected to an image forming apparatus, sets a printing property of two or more printing jobs and improves a processing speed, and an image forming method thereof.

Additional aspects and/or advantages of the present general inventive concept will be set forth in part in the description which follows and, in part, will be obvious from the description, or may be learned by practice of the present general inventive concept.

The foregoing and/or other aspects and utilities of the present general inventive concept can be achieved by providing a host apparatus which is connected to an image forming apparatus, the host apparatus including an image processor to process an image with respect to a printing data, and a controller to check a preset common printing property for two or more of the printing data, to set a common printing property to be applied for the two or more selected printing data and to control the image processor to process the image with respect to the selected printing data and to transmit the set common printing property with the selected printing data to the image forming apparatus.

The controller may restore the checked preset common printing property after completing forming the image with respected to the selected printing data.

The controller may set the common printing property to be applied for the selected printing data together.

The selected printing data may include spooled data.

The controller may set the printing property of the two or more printing data individually if the preset common printing property is not checked.

The controller may use a command SET and a command DEFAULT of printer job language (PJL).

The host apparatus may further include a storage unit to store the checked preset common printing property therein.

The preset common printing property may be set in the image forming apparatus.

The foregoing and/or other aspects and utilities of the present general inventive concept can be achieved by providing an image forming method of a host apparatus connected to an image forming apparatus, the method including selecting printing data, checking a preset common printing property for two or more of the printing data, setting a common printing property to be applied for the two or more selected printing data, and transmitting the set common printing property and the selected printing data to the image forming apparatus.

The image forming method may further include restoring the checked preset common printing property after completing forming the image with respect to the selected printing data.

The setting the common printing property may include setting a common printing property to be applied for the selected printing data together.

The selected printing data may include spooled data.

The checking the common printing property may further include individually setting a printing property to the two or more printing data if the preset common printing property is not checked.

The setting the common printing property may include setting the common printing property with a command SET and a command DEFAULT of printer job language (PJL).

The checking the common printing property may further include storing the checked common printing property.

The preset common printing property may be set in the image forming apparatus.

The foregoing and/or other aspects and utilities of the general inventive concept may also be achieved by providing an image forming method, comprising selecting a printing job, selecting a printing property to correspond with the selected printing job, requesting a preset common printing property from an image forming apparatus, determining whether the preset common printing property exists in the image forming apparatus and performing a course of action based on the determination of whether the present common printing property exists.

The performing a course of action may comprises adding a command before printing data corresponding to the selected printing job and the printing property, and transmitting the printing data to the image forming apparatus, when the determination is that the present common printing property does not exist.

The command may comprise a SET command.

The performing a course of action may comprise storing the common printing property preset in the image forming apparatus, adding a command before printing data corresponding to the printing property and the printing job, and adding the command after last printing data corresponding to the stored printing property and the printing job, when the determination is that the present common printing property exists.

The command may comprise a DEFAULT command.

The foregoing and/or other aspects and utilities of the general inventive concept may also be achieved by providing a computer-readable recording medium having embodied thereon a computer program to execute a method, wherein the method comprises selecting a printing job, selecting a printing property to correspond with the selected printing job, requesting a preset common printing property from an image forming apparatus, determining whether the preset common printing property exists in the image forming apparatus, and performing a course of action based on the determination of whether the present common printing property exists.

The foregoing and/or other aspects and utilities of the general inventive concept may also be achieved by providing an image forming system, comprising an image forming apparatus to form an image, and a host apparatus to receive a print job selection and a printing property selection corresponding to the selected print job, to request a preset common printing property from the image forming apparatus, to determine whether the preset common printing property exists in the image forming apparatus, and to perform a course of action based on the determination of whether the present common printing property exists.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIG. 1 illustrates a command which is generated by a conventional host apparatus to set a printing property of two or more printing jobs;

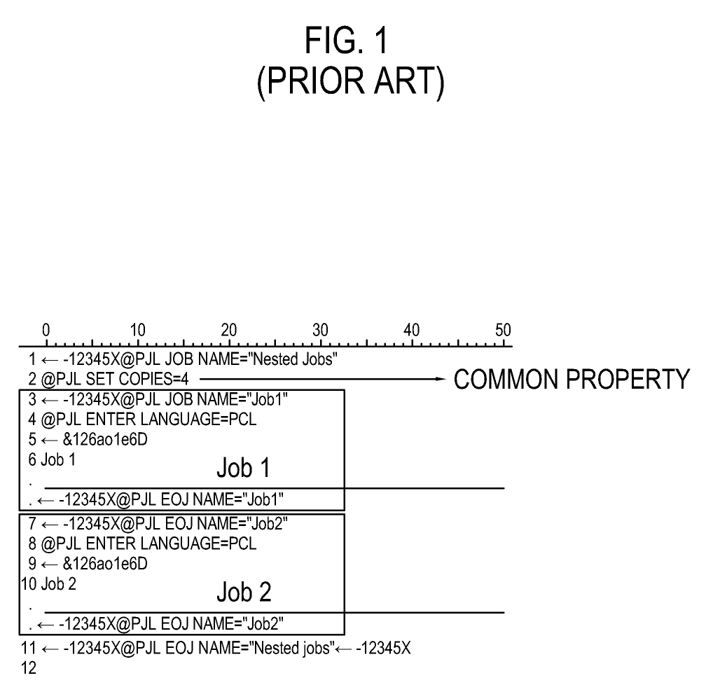

FIG. 2 is a block diagram illustrating a host apparatus according to an exemplary embodiment of the present general inventive concept;

FIG. 3 illustrates a command which is generated by the host apparatus to set a printing property of two or more printing jobs according to the exemplary embodiment of the present general inventive concept;

FIG. 4 is a block diagram illustrating a host apparatus according to another exemplary embodiment of the present general inventive concept;

FIG. 5 is a block diagram illustrating the host apparatus and the image forming apparatus connected thereto according to an embodiment of the present general inventive concept;

FIG. 6 illustrates a user interface (UI) to set the printing property from the host apparatus according to an embodiment of the present general inventive concept;

FIG. 7 is a flowchart illustrating an image forming method of the host apparatus according to the embodiment of FIG. 2; and

FIG. 8 is a flowchart illustrating an image forming method of the host apparatus according to another exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

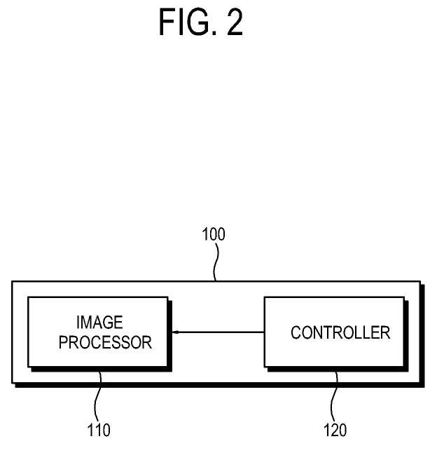

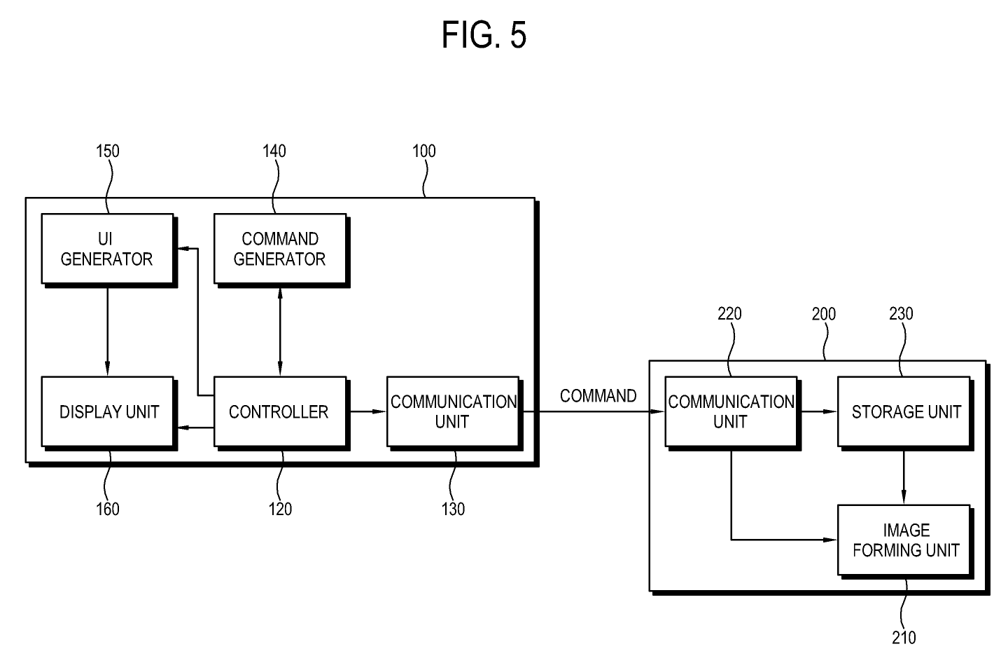

FIG. 2 is a block diagram illustrating a host apparatus according to an exemplary embodiment of the present general inventive concept. As illustrated therein, a host apparatus 100 according to the exemplary embodiment of the present general inventive concept includes an image processor 110 and a controller 120. The host apparatus 100 according to the present general inventive concept is connected to an image forming apparatus 200 (FIG. 5), and may include a PC, but not limited thereto. Alternatively, the host apparatus 100 may vary as long as the host apparatus (200) generates and transmits printing data.

The image processor 110 processes an image based on predetermined printing data. The image processor 110 according to the present embodiment processes an image, e.g. a gamma correction of the image, a shading adjustment of the image, etc. to output the printing data to a recording medium.

The controller 120 checks a preset common printing property in the image forming apparatus 200 to set a common printing property to be applied for the two or more printing data selected for the printing jobs, and controls the image processor 110 for image processing. The controller 120 transmits the set common printing property and the selected plurality of printing data for the printing jobs to the image forming apparatus 200.

Here, the controller 120 may restore the checked common printing property to the image forming apparatus 200 (FIG. 5) after the image forming apparatus 200 forms an image with the selected plurality of printing data.

The controller 120 according to the present embodiment includes software to set the printing property of the printing job. The software of the controller 120 may include a printer job language (PJL) generator (not illustrated) if a command language includes PJL to set the printing property.

A command language to set the printing property may include printer control language (PCL), and postscript (PS) instead of PJL. The controller 120 may include a command language generator corresponding to the respective command language to set the printing property of the printing job.

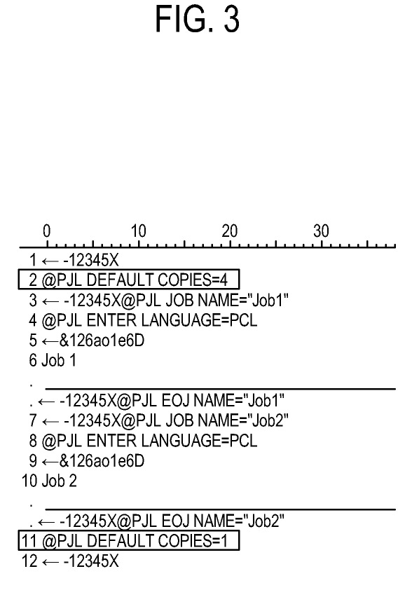

Hereinafter, operation of the controller 120 of the host apparatus 100 according to an embodiment of the present general inventive concept will be described with reference to FIG. 3.

To print four copies of the printing data for printing jobs of “Job 1” and “Job 2”, the controller 120 checks the preset common printing property. Here, the preset common printing property refers to printing one copy for the respective printing data. Thus, the controller 120 stores the preset common printing property (for restoration of the common printing property), and generates a command “DEFAULT COPIES=4” and adds the generated command to line 2 to set a printing property to be applied for two or more of the printing data as the common printing property.

If printing of the four copies with respect to “Job 1” and “Job 2” is completed, the controller 120 generates and adds a command “DEFAULT COPIES=1” corresponding to the stored preset printing property in line 11. Then, the controller 120 may set the printing property of the two or more printing jobs without a command “Nested Jobs.”

If the common printing property preset in the image forming apparatus 200 (FIG. 5) has not been checked, the controller 120 may set the printing property to be applied for the two or more printing data, respectively. In this case, the command to set the individual printing property is a command SET in PJL. The command “SET COPIES=4” respectively set to the two or more printing jobs performs a same function corresponding to a function of the command “Nested Jobs.”

If the controller 120 determines that a size of the recording medium is different from a size of a recording medium for the printing data while printing two or more of the printing data, the controller 120 changes the common printing property with the printing property corresponding to the size of the recording medium so that the remaining printing data corresponds to the size of the recording medium.

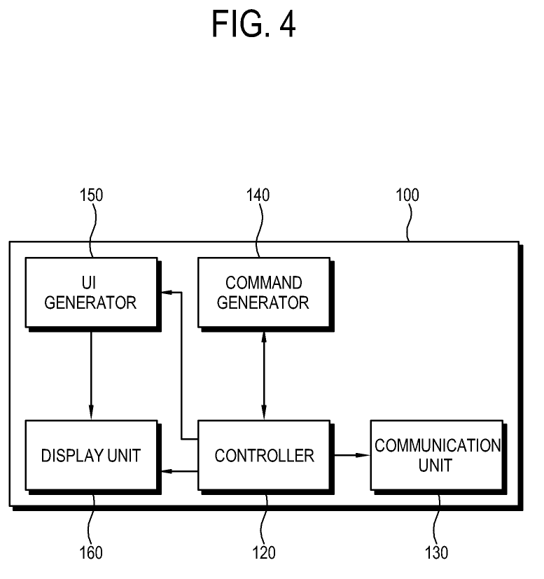

FIG. 4 is a block diagram illustrating a host apparatus 100 according to another exemplary embodiment of the present general inventive concept. As illustrated therein, the host apparatus 100 according to another exemplary embodiment of the present general inventive concept further includes a communication unit 130, a command language generator 140, a user interface (UI) generator 150 and a display unit 160.

The communication unit 130 transmits the common printing property set in two or more printing jobs, and selected printing data corresponding to the printing jobs to an image forming apparatus 200 (FIG. 5) by a control of a controller 120. The communication unit 130 may transmit a command generated by the command language generator 140 of the host apparatus 100 to the image forming apparatus 200. The communication unit 130 according to the present embodiment includes a USB interface, but not limited thereto. Alternatively, the communication unit 130 may be configured with wired or wireless device as long as the communication unit 130 can be connected to the image forming apparatus 200. For example, the communication unit 130 may transmit the printing property and printing data according to a command language standard compatible with the image forming apparatus 200 as well as a standard possible to be directly connected thereto such as Business to Business Solution (B2B Solution).

The command language generator 140 generates a command to set the printing property, and may include a PJL generator if the command is PJL.

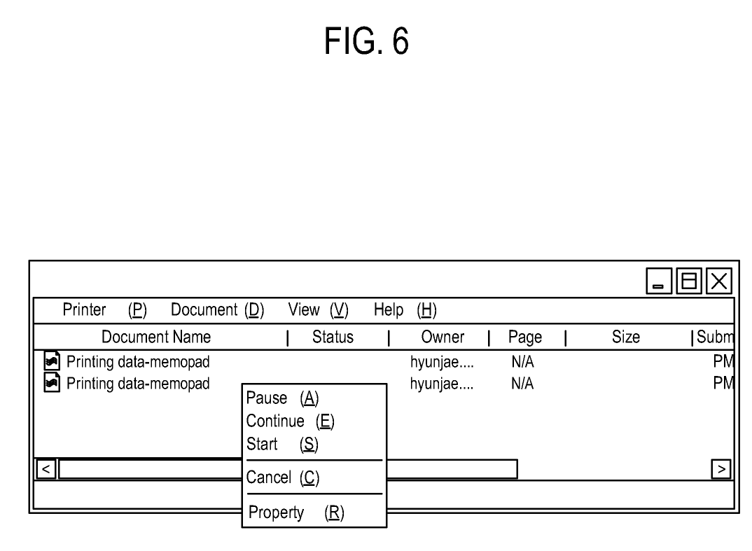

The UI generator 150 generates a UI to set the printing property of the two or more printing jobs. The display unit 160 displays the UI generated by the UI generator 160. The UI generated by the UI generator 150 according to the present embodiment will be described with reference to FIG. 6.

The host apparatus 100 may further include a user input unit (not illustrated) to set the printing property of the two or more printing jobs.

Hereinafter, the host apparatus 100 connected to the image forming apparatus 200 according to another exemplary embodiment of the present general inventive concept will be described with reference to FIG. 5.

The host apparatus 100 according to the present embodiment checks the common printing property set in the image forming apparatus 200 through the communication unit 130, and stores it. The host apparatus 100 generates the command to set the common printing property to be applied for the two or more printing jobs selected by a user's input, and transmits the command to the image forming apparatus 200.

The image forming apparatus 200 includes an image forming unit 210, a communication unit 220 and a storage unit 230.

The image forming unit 210 forms an image based on the received printing property and printing data. The image forming unit 210 according to the present embodiment includes a photosensitive body (not illustrated) to form an electrostatic latent image thereon, a developing unit (not illustrated) to develop a developer to the photosensitive body, and a transfer unit (not illustrated) to transfer the developer developed to the photosensitive body to a recording medium such as paper and form an image on the paper.

The communication unit 220 receives the printing property and the printing data from the host apparatus 200. The communication unit 220 may transmit the printing property and the printing data according to a command standard compatible with the host apparatus 100 regardless of a configuration provided wired or wirelessly, like the communication unit 130 of the host apparatus 100.

The storage unit 230 stores the common printing property preset in the image forming apparatus 200. The storage unit 230 may include a nonvolatile memory such as flash memory. Alternatively, the storage unit 230 may be provided in the host apparatus 100.

If the printing property and printing data are received from the host apparatus 100 through the communication unit 220, the image forming apparatus 200 changes the preset common printing property into the received printing properties, and forms an image. If the two or more printing jobs are finished, the host apparatus 100 may restore the printing property according to the stored common printing property. Here, the image forming apparatus 200 may include a parser to parse the command corresponding to the received printing properties.

FIG. 6 illustrates a UI which is generated by the UI generator 150 according to an embodiment of the present general inventive concept. As illustrated therein, a user may select “printing data 1” and “printing data 2” for the printing jobs, and set the common printing property of the selected printing data at a time. Here, the data selected by a user includes spooled data.

As described above, the printing property of the two or more printing jobs may be set with the command from the conventional PJL without difficulty, and processing speed may be improved.

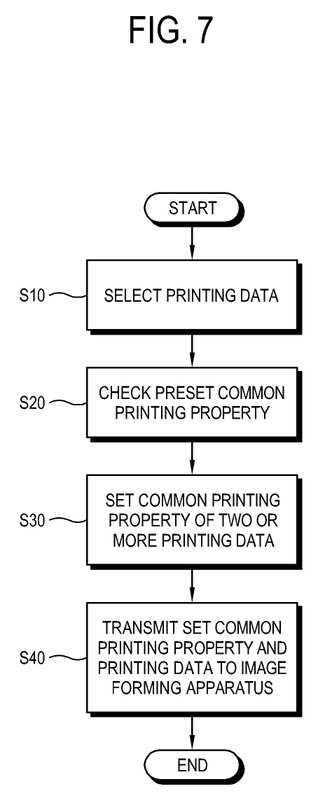

Hereinafter, an image forming method according to the embodiment of FIG. 2 will be described with reference to FIG. 7.

Referring to FIGS. 2, 5 and 7, if the printing data is selected (operation S10), the controller 120 of the host apparatus 100 checks the preset common printing property in the image forming apparatus 200 (operation S20).

The controller 120 sets the common printing property to be applied for the two or more printing jobs selected at operation S10 (operation S30). At operation S30, the common printing property of the selected printing data may be set by the UI generated by the UI generator 150 at a time.

The host apparatus 100 transmits the common printing property set at operation S30 and the printing data to the image forming apparatus 200 (operation S40).

If the image is formed with the selected printing data, the operation S40 may include an operation to restore the common printing property checked (back to the stored property) at operation S20.

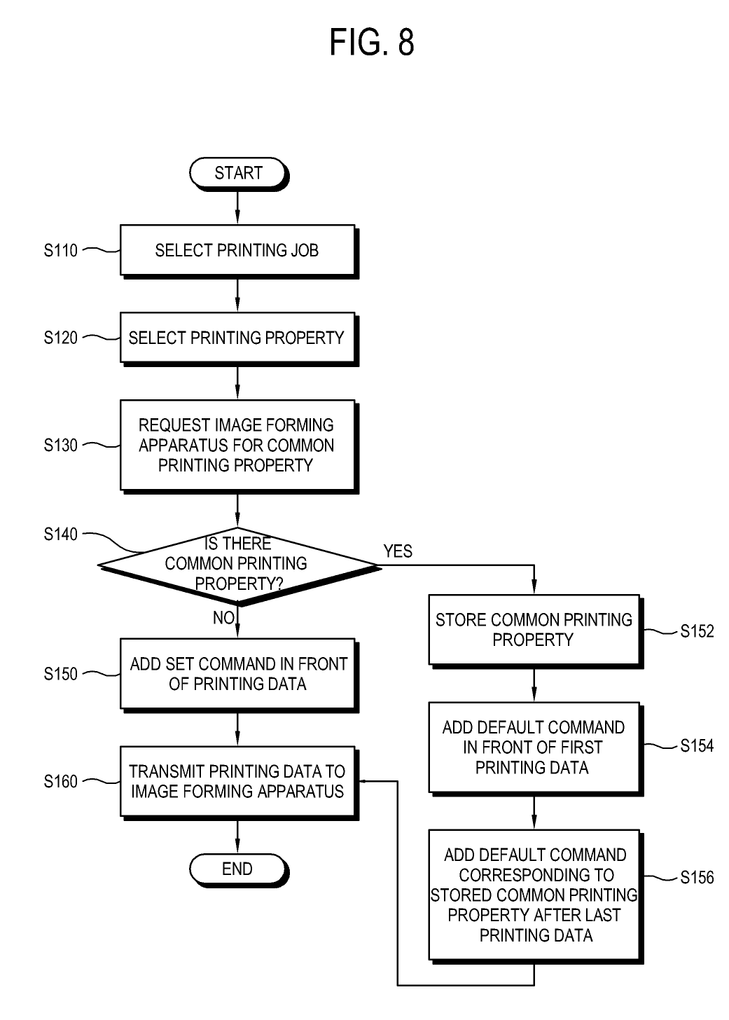

Hereinafter, an image forming method of the host apparatus 100 according to another exemplary embodiment of the present general inventive concept will be described with reference to FIG. 8.

Referring to FIGS. 5 and 8, a user selects the printing jobs from the host apparatus 100 (operation S110), and selects the printing property to be applied for the selected printing jobs (operation S120). The host apparatus 100 requests the preset common printing property in the image forming apparatus 200 (operation S130).

The host apparatus 100 determines whether the common printing property exists in the image forming apparatus 200 (operation S140). If the common printing property does not exist in the image forming apparatus 200, the host apparatus 100 adds the command SET before the printing data according to the selected printing job and the printing property (operation S150).

If the common printing property is preset in the image forming apparatus 200, the host apparatus 100 stores the common printing property preset in the image forming apparatus 200 (operation S152). Then, the host apparatus 100 adds a command DEFAULT before the first printing data corresponding to the printing property and the printing data selected by a user (operation S154). Then, the host apparatus 100 adds a command DEFAULT after the last printing data corresponding to the printing property stored at operation S152 and the printing job selected by a user (operation S1 56).

Lastly, the host apparatus 100 transmits the printing data to the image forming apparatus 200 to form an image according to the generated command (operation S160).The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, various embodiments of the present general inventive concept provide a host apparatus connected to an image forming apparatus and an image forming method thereof, which sets a printing property of two or more printing jobs with a command supplied from a conventional PJL without difficulty.

Also, various embodiments of the present general inventive concept provide a host apparatus connected to an image forming apparatus and an image forming method thereof, which sets a printing property of two or more printing jobs, and improves a processing speed.

Although various exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A host apparatus which is connected to an image forming apparatus, the host apparatus comprising:
an image processor to process an image with respect to printing data; and
a controller to check a preset common printing property for two or more of the printing data, to set a common printing property to be applied for the two or more selected printing data and to control the image processor to process the image with respect to the selected printing data and to transmit the set common printing property with the selected printing data to the image forming apparatus.

2. The host apparatus according to claim 1, wherein the controller restores the checked preset common printing property after completing forming the image with respected to the selected printing data.

3. The host apparatus according to claim 1, wherein the controller sets the common printing property to be applied for the selected printing data together.

4. The host apparatus according to claim 3, wherein the selected printing data comprises:
spooled data.

5. The host apparatus according to claim 1, wherein the controller sets the printing property of the two or more printing data individually if the preset common printing property is not checked.

6. The host apparatus according to claim 1, wherein the controller uses a command SET and a command DEFAULT of printer job language (PJL).

7. The host apparatus according to claim 1, further comprising:
a storage unit to store the checked preset common printing property therein.

8. The host apparatus according to claim 1, wherein the preset common printing property is set in the image forming apparatus.

9. An image forming method of a host apparatus connected to an image forming apparatus, the method comprising:
selecting printing data;
checking a preset common printing property for two or more of the printing data;
setting a common printing property to be applied for the two or more selected printing data; and
transmitting the set common printing property and the selected printing data to the image forming apparatus.

10. The image forming method according to claim 9, further comprising:
restoring the checked preset common printing property after completing forming the image with respect to the selected printing data.

11. The image forming method according to claim 9, wherein the setting the common printing property comprises:
setting a common printing property to be applied for the selected printing data together.

12. The image forming method according to claim 11, wherein the selected printing data comprises:
spooled data.

13. The image forming method according to claim 9, wherein the checking the common printing property further comprises:
individually setting a printing property to the two or more printing data if the preset common printing property is not checked.

14. The image forming method according to claim 9, wherein the setting the common printing property comprises:
setting the common printing property with a command SET and a command DEFAULT of printer job language (PJL).

15. The image forming method according to claim 9, wherein the checking the common printing property further comprises:
storing the checked common printing property.

16. The image forming method according to claim 9, wherein the preset common printing property is set in the image forming apparatus.

17. An image forming method, comprising:
selecting a printing job;
selecting a printing property to correspond with the selected printing job;
requesting a preset common printing property from an image forming apparatus;
determining whether the preset common printing property exists in the image forming apparatus; and
performing a course of action based on the determination of whether the present common printing property exists.

18. The method of claim 17, wherein the performing a course of action comprises:
adding a command before printing data corresponding to the selected printing job and the printing property, and transmitting the printing data to the image forming apparatus, when the determination is that the present common printing property does not exist.

19. The method of claim 17, wherein the performing a course of action comprises:
storing the common printing property preset in the image forming apparatus, adding a command before printing data corresponding to the printing property and the printing job, and adding the command after last printing data corresponding to the stored printing property and the printing job, when the determination is that the present common printing property exists.

20. A computer-readable recording medium having embodied thereon a computer program to execute a method, wherein the method comprises:
selecting a printing job;
selecting a printing property to correspond with the selected printing job;
requesting a preset common printing property from an image forming apparatus;
determining whether the preset common printing property exists in an image forming apparatus; and
performing a course of action based on the determination of whether the present common printing property exists.

21. An image forming system, comprising:
an image forming apparatus to form an image; and
a host apparatus to receive a print job selection and a printing property selection corresponding to the selected print job, to request a preset common printing property from the image forming apparatus, to determine whether the preset common printing property exists in the image forming apparatus, and to perform a course of action based on the determination of whether the present common printing property exists.
